(19) United States
(12) Patent Application Publication
(10) Pub. No.: US 2015/0072756 A1
(43) Pub. Date: Mar. 12, 2015

(54) GAMING MACHINE AND METHOD USING HELP LINE INDICATORS

(71) Applicant: Atlas Gaming Technologies Pty. Ltd., Port Melbourne (AU)

(72) Inventors: DANIEL JULIO MONTENEGRO, Port Melbourne (AU); ZENJA SOLAJA, Port Melbourne (AU); ROBERT SLOOT, Port Melbourne (AU); ALESSANDRO CIAMPOLI, Port Melbourne (AU); BORIS MITLEMAN, Port Melbourne (AU); WADE CLARK, Port Melbourne (AU)

(73) Assignee: Atlas Gaming Technologies Pty. Ltd., Port Melbourne (AU)

(21) Appl. No.: 14/260,223

(22) Filed: Apr. 23, 2014

(30) Foreign Application Priority Data
Apr. 24, 2013 (AU) AU2013901436

(51) Int. Cl. G07F 17/34; G07F 17/32

(52) U.S. Cl. CPC G07F 17/34; G07F 17/3213
USPC 463/20

(57) ABSTRACT

Embodiments generally relate to gaming machines and methods related to allowing a user to easily view the available play lines for a particular game. One embodiment includes a display operable to display images, a user interface configured to receive input from a player, a memory and a game controller configured to access the memory, control generation and display of the images and to process input received via the user interface. The game controller is further configured to control generation and display of a game play sequence that includes a presentation of one or more games of chance; store in the memory data describing a plurality of available play lines for the game play sequence, wherein each of the available play lines comprises a graphical representation of a unique pattern of selected symbols; receive from the player via the user interface a selection of the plurality of available play lines.

### CROSS-REFERENCE TO RELATED APPLICATIONS

The present application claims priority from Australian Provisional Patent Application No 2013901436 filed on 24 Apr. 2013, the content of which is incorporated herein by reference.

### TECHNICAL FIELD

Described embodiments generally relate to a gaming machine running a spinning reel or slot style game which allows for multiple paths across the reels to be considered winning play lines. In particular, described embodiments are directed to a gaming machine which allows the user to easily view the available and enabled play lines for a particular game.

### BACKGROUND

Slot machines are a common type of gaming machine, having a number of spin-able reels displaying a variety of symbols. While the reels may be mechanical, they are most often virtual reels displayed on a screen. Triggered by a user input, the reels spin and each comes to a stop at a random position. Wins are calculated based on the combination of symbols displayed on a particular line when the reels stop spinning. In some cases, the combination of symbols is read horizontally across the centre line. In other cases, however, the line in play may be diagonal, form a “V”, or be some other path across the reels.

As the gaming machine industry has grown, more complex games have been developed to keep users interested. Slot machines have become more complex by offering multiple lines of play at a time, and allowing the user to choose which lines to enable from a selection of multiple play lines. Some machines now allow the user to play hundreds of lines at a time, with each line having a unique pattern. While this makes the game more interesting for users, it can be challenging to learn all of the lines available in a given game, and particularly which lines are in play at any given time.

In some gaming machines, users can navigate to a “Help” screen that will show them the selection of lines they have in play. However, finding this screen can be difficult, and may require navigation through a series of intermediate screens. Furthermore, once the player reaches the screen, the result of their game is no longer visible. Having completed a game, the player may wish to verify that the machine has calculated the correct result, and to do so, the player will need to check the lines in play against the symbols on the final position of the reels. To verify that the correct result was reported by the gaming machine, the user may need to navigate forwards and backwards through the screens multiple times, to check the result of each line in play.

It is desired to address or ameliorate one or more shortcomings or disadvantages associated with prior systems for displaying multiple play lines on gaming machines, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some embodiments relate to a gaming machine comprising:
a display to display images;
a user interface to receive input from a player;
a memory; and
a game controller configured to access the memory, control display of the images and process input received via the user interface, the game controller further configured to:
   control generation and display of a game play sequence comprising a presentation of one or more games of chance;
   store in the memory data describing a plurality of available play lines for the game play sequence, wherein each of the available play lines comprises a graphical representation of a unique pattern of selected symbols;
   receive from the player via the user interface a selection of the plurality of available play lines;
   in response to the received input from the player, display a help line pattern indicator in proximity to the presentation on the display, wherein the help line pattern indicator comprises at least a subset of the plurality of available play lines including each of the selected play lines; and to control display of the graphical representations in the help line pattern indicator to graphically distinguish each of the selected available play lines from remaining play lines.
   In some embodiments, graphically distinguishing each of the selected available play lines from remaining play lines may comprise highlighting the selected available play lines, or providing only the selected available play lines in colour whilst providing the remaining available play lines in greyscale.

The user interface may comprise a touch screen which interfaces with the display. The user interface may comprise at least one virtual button, wherein input from the player is by way of a finger touch of or in proximity to the button displayed. Optionally input from the player may be received via a physical button or switch or another input sensor.

In some embodiments, a summary indication of selected and selectable play lines may be displayed adjacent the presentation of one or more games of chance or near the periphery of the display. The summary indication may indicate how many of the selectable play lines are selected for the succeeding game of chance and may indicate a total of how many play lines are selectable.

In some embodiments, the virtual button may comprise the summary indication of selected and selectable play lines. In these or other embodiments, when the controller detects that the virtual button has been activated the appearance of the virtual button may change. For instance it may change colour, or when the virtual button has a three dimensional appearance the virtual button may appear to move into or away from the display.

In some embodiments, the game controller is further configured such that upon receipt of the received input from the player an audio output is generated. The audio output may persist for a second or a few seconds or the audio output may persist for as long as the help line pattern indicator is displayed.

The game controller may further be configured to display in the presentation one or more play line indications comprising a sequence of graphical patches, each graphical patch associated with a selectable play line.

Each of the one or more selected play line indications may be positioned at or near a periphery of the display and each may indicate which one or more of a plurality of selectable play lines are active for a succeeding game of chance.

The selectable play lines indications representing inactive play lines may be displayed with a transparent graphical patch while the play line indications representing active play lines may be displayed with an opaque graphical patch. All selectable play lines may be grouped together and may be non-overlapping.

Each of the selectable play lines may have a unique identifier, which may comprise a number of the play line, for example. This unique identifier may be displayed over the graphical patch for the respective play line during selected times or events, such as when indicating a winning play line, when selected play lines change or when displaying a help sequence, for example.

Some embodiments relate to a gaming system comprising at least one gaming machine as described above and at least one server system in communication with the game controller of the at least one gaming machine.

Some embodiments relate to a method of game play executed by a computerised game controller, the method comprising:
controlling generation and display of a game play sequence comprising a presentation of one or more games of chance;
storing in a memory data describing a plurality of available play lines for the game play sequence, wherein each of the available play lines comprises a graphical representation of a unique pattern of selected symbols;
receiving from a player via a user interface a selection of the plurality of available play lines; in response to the received input from the player,
displaying a help line pattern indicator in proximity to the presentation on the display, wherein the help line pattern indicator comprises at least a subset of the plurality of available play lines including each of the selected play lines; and
controlling display of the graphical representations in the help line pattern indicator to graphically distinguish each of the selected available play lines from remaining play lines.

In some embodiments, the method further comprises graphically distinguishing each of the selected available play lines from remaining play lines. This may comprise highlighting the selected available play lines, or providing only the selected available play lines in colour whilst providing the remaining available play lines in greyscale.

In some embodiments, the method further comprises displaying a summary indication of selected and selectable play lines adjacent the presentation of one or more games of chance or near the periphery of the display. The summary indication may indicate how many of the selectable play lines are selected for the succeeding game of chance and may indicate a total of how many play lines are selectable.

In some embodiments, the method may further comprise detecting whether the virtual button has been activated, and changing the appearance of the virtual button.

In some embodiments, the method may further comprise generating audio output on receipt of the received input from the player.

In some embodiments, the method may further comprise displaying in the presentation one or more play line indications comprising a sequence of graphical patches, each graphical patch associated with a selectable play line. The selectable play lines indications representing inactive play lines may be displayed with a transparent graphical patch while the play line indications representing active play lines may be displayed with an opaque graphical patch.

In some embodiments, the method may further comprise displaying a unique identifier over the graphical patch for a play line during selected times or events, such as when indicating a winning play line, when selected play lines change or when displaying a help sequence, for example. The unique identifier may comprise a number of the play line, for example.

Some embodiments relate to a gaming system comprising at least one server and at least one client device, wherein the at least one server and at least one client device are configured to cooperate with each other to execute program instructions to:
control generation and display of a game play sequence comprising a presentation of one or more games of chance;
store in a memory data describing a plurality of available play lines for the game play sequence, wherein each of the available play lines comprises a graphical representation of a unique pattern of selected symbols;
receive from a player via a user interface a selection of the plurality of available play lines; in response to the received input from the player,
display a help line pattern indicator in proximity to the presentation on the display, wherein the help line pattern indicator comprises at least a subset of the plurality of available play lines including each of the selected play lines; and
control display of the graphical representations in the help line pattern indicator to graphically distinguish each of the selected available play lines from remaining play lines.

Some embodiments relate to computer-readable storage storing executable program code that, when executed by a game controller, causes the game controller to perform the methods described above and/or implement the features and functions of the game machine or game system described above.

### BRIEF DESCRIPTION OF DRAWINGS

Embodiments are described in further detail below, by way of example and with reference to the accompanying drawings, in which:

FIG. 1 shows a perspective view of a gaming machine;

FIG. 2 shows a block diagram of a game logic circuit of the gaming machine illustrated in FIG. 1;

FIG. 3 shows a block diagram of functional components of a gaming system incorporating gaming machines illustrated in FIG. 1

FIG. 4 shows an example client side display that may appear on the screen of the gaming machine illustrated in FIG. 1, showing a spinning reel game with five reels; and

FIG. 5 shows an example client side display that may appear on the screen of the gaming machine illustrated in FIG. 1, showing a spinning reel game in play with a help line pattern indicator visible.

### DETAILED DESCRIPTION

Described embodiments generally relate to a gaming machine running a spinning reel or slot style game which allows for multiple paths across the reels to be considered winning play lines. In particular, described embodiments are directed to a gaming machine which allows the user to easily view the available and enabled play lines for a particular game.

The gaming system can take a number of different forms. In a first form, a stand-alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

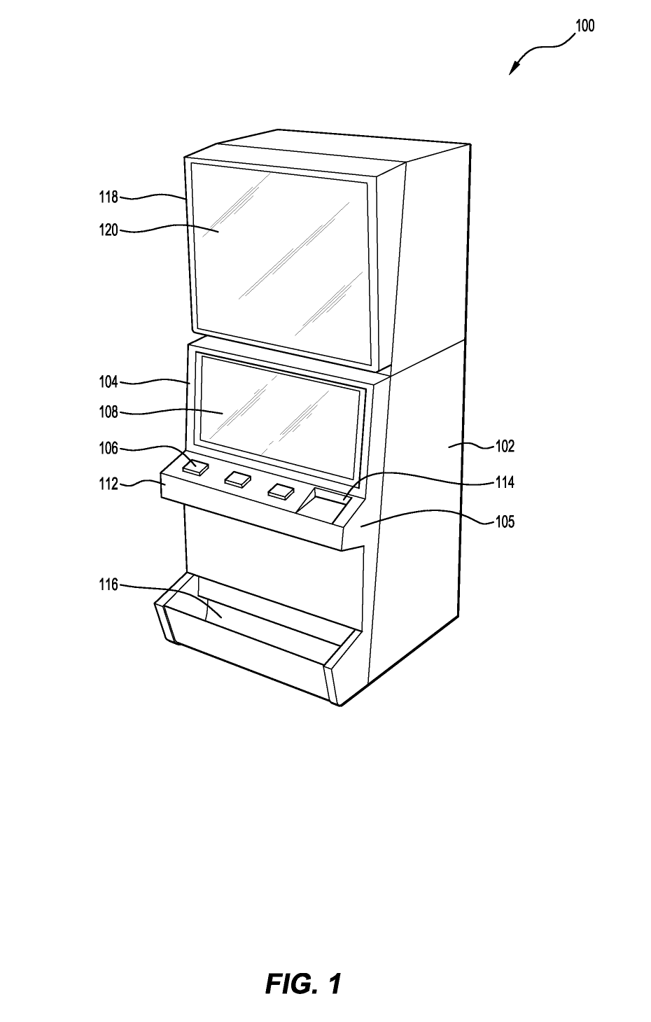

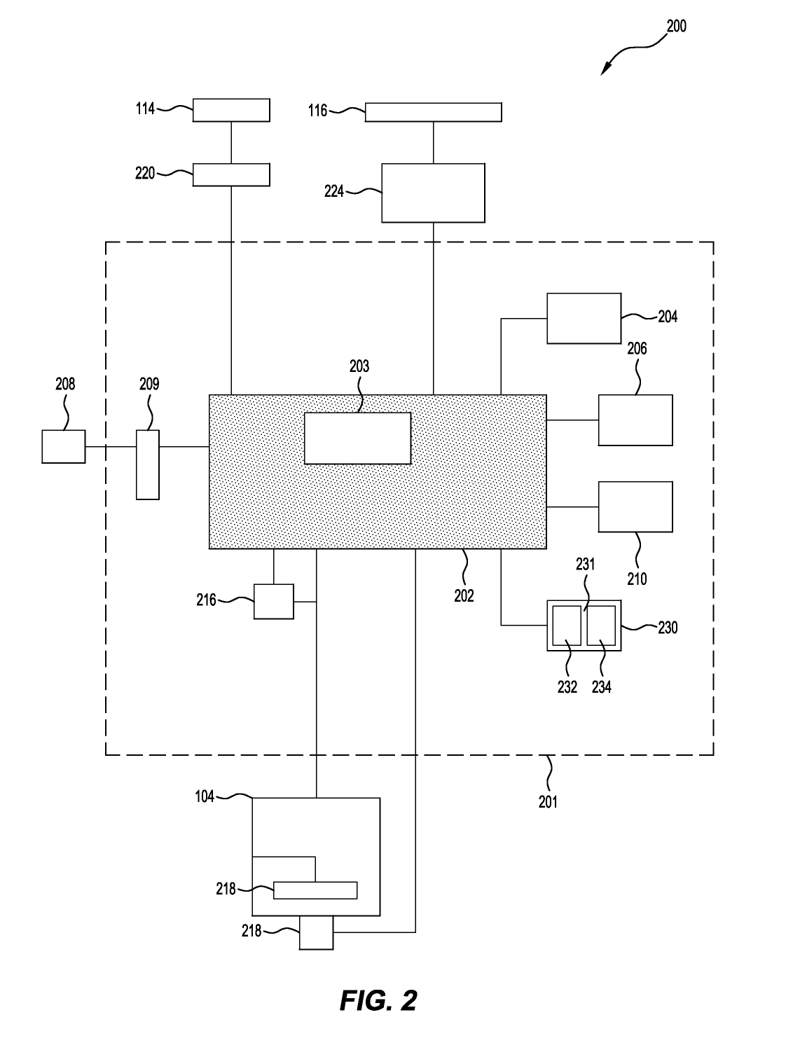

In another form, the gaming system may comprise a gaming server (or multiple gaming servers) interacting with client computing devices over a wired and/or wireless network to allow performance of the games on the client devices. Such client devices may include desktop computers, tablet computers, laptop computer and handheld computing devices (including smart phones), for example, each of which includes at least one processor and memory to store executable instructions for performing the game-related functions described herein. Such systems may therefore not require specific dedicated physical gaming machines as described herein in relation to FIGS. 1 and 2, since the client devices can in such systems perform some of the gaming functions as described herein. In such gaming systems, the client devices may locally execute gaming applications that communicate with the gaming server and, in combination with the gaming server, provide a user interface and gaming experience generally similar to that of a physical gaming machine. Thus, embodiments described herein in relation to gaming machines may be implemented “on-line” using such a client-server architecture, unless such implementations would not be physically or technologically feasible. Additionally, some embodiments described herein in relation to gaming machines may be implemented in a personal computing device without requiring interaction with a server, in which case such computing devices can be termed “gaming machines”.

One or more of the method steps described in this disclosure may be implemented by executable instructions and parameters 232, 234 (See FIG. 2), stored in the memory 204, 206, 230 (See FIG. 2), that may form software embodiments of the system 100. These instructions 232, 234 that form the system 100 may be executed by the CPU 202 (See FIG. 2) or any other processor. Further, the processor 202, the memory 204, 206, 230, the instructions 232, 234 stored therein, or a combination thereof may serve as a means for performing one or more of the method steps described herein.

Irrespective of the form, the gaming system 100 has several core components. At the broadest level, the core components are a player interface in the form of a touch screen 108 as illustrated in FIG. 1 and a game controller 200 as illustrated in FIG. 2. The player interface is arranged to enable manual interaction between a player and the gaming system and for this purpose includes the input/output components required for the player to enter instructions and play the game.

Referring now to FIG. 1, reference numeral 100 generally designates a stand-alone gaming system including a game. Hereinafter, the stand-alone gaming system 100 will be referred to as a gaming machine.

The gaming machine 100 includes a console 102 which contains all or most components required to implement a game play whereby a player wins or loses a wager. Access to the components is by way of a hinged door 105. Moulded to the exterior of the console 102 is a display means in the form of at least one visual display unit 104 on which one or more games is played. The video display unit 104 may be implemented as a liquid crystal display, a plasma screen, as a cathode ray screen device or the like. Whilst the console 102 illustrated in FIG. 1 shows a single visual display unit 104, there can be more than one visual display unit on a typical machine. What is displayed on the visual display unit 104 will depend on what the intended goal of the unit is in relation to the player and any other potential participants in the gaming system.

The gaming machine includes a tactile input for a player to interact via touch with the gaming machine 100. In this example, the tactile input is in the form of a combination of pushbuttons 106 and a touch screen 108 for enabling a player to play one or more games. The touch screen is an electronic visual display that can detect the presence and location of a touch within the display area. The touch screen 108 is used during the game play between start of a game and the end of a game. A game is considered to have started once a wager is placed and considered complete once the wager has been lost or won. Certain functions of the pushbutton are: initiation of game play, credit output, gameplay selection, completion of gameplay etc. A midtrim 112 of the machine 100 houses the pushbuttons 106.

The tactile input may optionally or further include a joystick comprising of a stick that pivots on a base and reports its angle or direction to the device it is controlling. The tactile input may optionally or further include a trackpad/touchpad being a pointing device featuring a tactile sensor to translate the motion and position of a user's fingers to a relative position on screen.

It should be appreciated that tactile input may include any suitable device that enables the player to produce an input signal that is received by the processor. Tactile input in the form of pushbuttons 106 and/or regions on touch screen 108 may include a one bet button, a max bet button, or a repeat the bet button. With a one bet button for instance, the player places a bet by pushing the one bet button. The player may increase the bet by one credit each time the player pushes the bet one button.

The midtrim 112 also houses credit input device including a bill collector 114. The credit input device may further include a coin input chute, a card and/or ticket reader, a magnetic reading head for reading a magnetic stripe card, an electronic reader for a proximity card, a near field communications reader or any other form of electronic, wireless or contact that can input credit to the gaming machine.

A credit dispenser in the form of a coin tray 116 is mounted beneath the console 102 and is provided for cash payouts from the machine 100 to the player. A hopper device (not shown) is provided which dispenses coins, or tokens equal to the amount of credit currently on the machine, into the coin tray 116. Aside from the coin tray 116, the credit dispenser may also include a ticket dispenser for issuing a ticket dispensed by a printer which the user can redeem for cash, a note dispenser, a near field communications transmitter or means to enable remote credit transfer. It should be appreciated that any suitable payout mechanisms, such as funding to the player's electronically recordable identification card or smart card, may be implemented in accordance with the gaming machine disclosed herein.

The gaming machine 100 includes a top box 118 on which artwork 120 is carried in the form of electronic visual display units. The artwork 120 could also be made from physical materials such as paper, plastic banners or posters. The artwork 120 may have generic information related to the machine or gaming system or the artwork 120 be specifically made for a particular game to be played on the machine 100. Whilst the artwork 120 is shown as being carried on the top box 118 the art work 120 can also be positioned in or on the bottom panel of the door 105, or any other part of the gaming machine 100 visible to the player.

The gaming machine 100 further includes an auditory unit in the form of speakers (not shown) to provide auditory feedback to the player of the gaming machine 100.

Referring to FIG. 2 of the drawings, game logic circuitry 200 is illustrated. The game logic circuitry 200 includes a gaming controller 201 (otherwise referred to as a logic cage) designated by the dashed lines. As will be appreciated by those skilled in the gaming industry, the logic cage 201 includes a box-like mechanical structure that has slots to guide logic cards into the proper location for electronically plugging into a backplane mounted at the rear of the cage structure. The backplane has connectors for accepting mating connectors on the logic cards. The logic cage and associated cards form one of the basic components of the gaming machine 100 and is securely housed within the cabinet of the gaming machine 100.

Central to the logic cage is a central processing unit 202 such as a processor, a microcontroller-based platform, a suitable integrated circuit, or one or more application-specific integrated circuits (ASIC's). The processor 202 is in communication with or operable to access or to exchange signals with at an outcome evaluator 203, RAM 204, ROM 206, a non-volatile memory in the form of a compact flash 230, an audio output 208 via an audio control module 209, and a random number generator 210. The audio control module 209 has its own digital signal processor, analogue to digital converters, amplifiers and other circuitry necessary to broadcast the output from the speakers. RAM 204 may include non-volatile RAM (NVRAM), magnetic RAM (MRAM), ferroelectric RAM (FeRAM), and other forms as commonly understood in the gaming industry.

Compact flash memory 230 is physically secured within a slot in the logic cage 201. In one embodiment, the compact flash memory 230 is physically secured inside the logic cage within game logic circuitry 200 by a mechanical locking mechanism. Compact flash memory 230 is partitioned 231 into two parts. A first part comprises a game software module 232 and a second part comprises a metering information module 234.

The processor 202 runs executable code residing in game software module 232 of compact flash 230 that facilitates play of the game by a player through the display device and/or push buttons and touch sensors mounted in the screen of the display. Metering information module 234 contains the gaming machine parameters which include values that would usually be stored on a hard meter. The values in metering information module 234 are only ever incremented, and cannot be reset or decremented. The only way to alter the values stored is by running the executable code stored in game software module 232, which is executed by processor 202. The executable code further interacts with the credit dispenser 116 via a payout mechanism 224 and the auditory output 208. The game software module 232 contains the rules of the game, the sequence of gameplay, communicates with external systems, monitors peripheral equipment, maintain integrity of the software code, etc. The processor 202 continually checks for error conditions.

A program which implements the game logic circuitry 200 and the user interface is further run by the central processing unit 202. The processor 202 forms part of a controller 216 that drives the screen of the video display unit 104 and that receives input signals from sensors 218. The sensors 218 include sensors associated with the push buttons and touch sensors mounted in the screen of the video display unit 104. The controller 214 also receives input pulses from mechanisms 220 and 224 to determine whether or not a player has provided sufficient credit from either payment device 114 or payment device 116 to commence playing.

In one embodiment, a player may insert an identification card into a card reader (not shown) of the gaming machine 100. Such an identification card may be a smart card having a programmed microchip, a coded magnetic strip, or coded rewritable magnetic strip, wherein the programmed microchip or magnetic strips are coded with a player's identification, credit totals (or related data), and/or other relevant information. In another embodiment, a player may carry a portable device, such as a mobile phone, a radio frequency identification tag, or any other suitable wireless device, that communicates a player's identification, credit totals (or related data), and other relevant information to the gaming device.

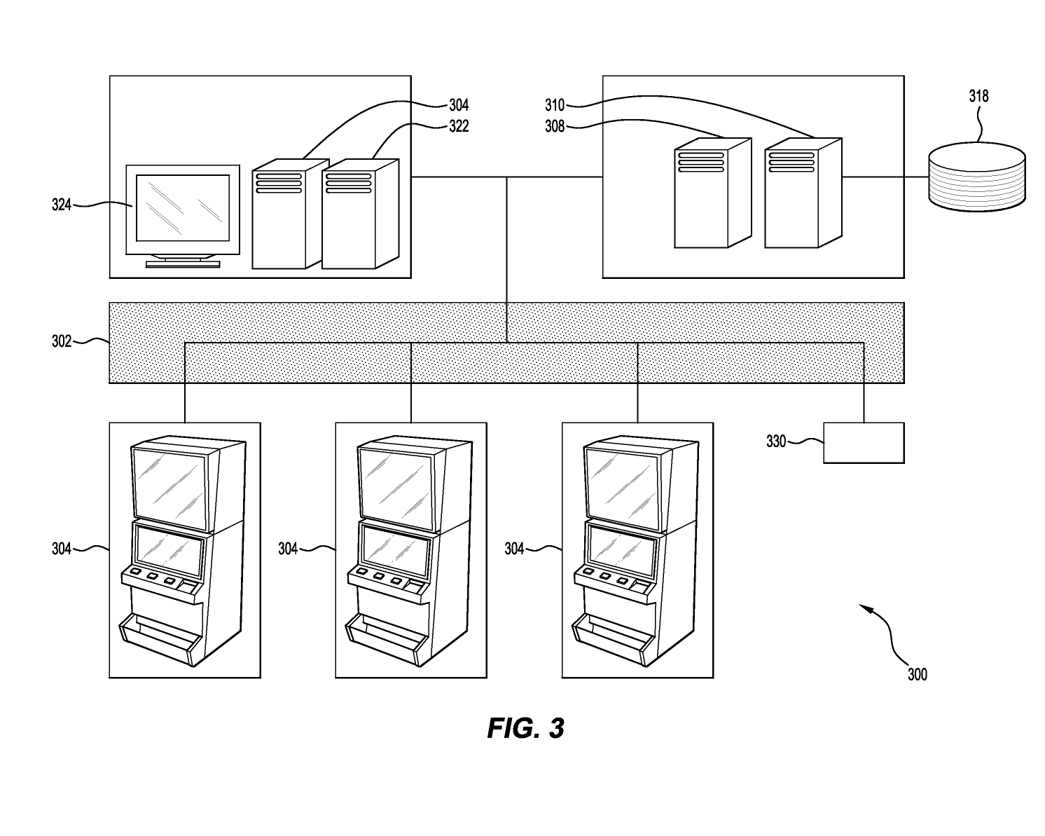

FIG. 3 shows a gaming system 300 in accordance with an alternative embodiment. The gaming system 300 includes a network 302, which for example may be an Ethernet network. The network 302 may also comprise a wide area network (“WAN”), the plain-old-telephone-system (“POTS), a local area network (“LAN”), a wireless LAN, the Internet, or any combination of these and other types of networks. Gaming machines 304 are connected to the network 302. The gaming machines 304 provide a player operable interface and may be the same as the gaming machines 100 shown in FIG. 1 or may have simplified functionality depending on the requirements for implementing game play.

In a thick client embodiment, game server 308 implements part of the game played by a player using a gaming machine 304 and the gaming machine 304 implements part of the game. With this embodiment, as both the game server 308 and the gaming device implement part of the game, they collectively provide a game controller. A database management server 310 may manage storage of game programs and associated data for downloading or access by the gaming devices 304 in a database 318.

In a thin client embodiment, game server 308 implements most or all of the game played by a player using a gaming machine 304 and the gaming machine 304 essentially provides only the player interface. With this embodiment, the game server 308 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 300, including for example a gaming floor management server 320, and a licensing server 322 to monitor the use of licenses relating to particular games. An administrator terminal 324 is provided to allow an administrator to run the network 302 and the devices connected to the network.

The gaming system 300 may communicate with other gaming systems, other local networks, for example a corporate network, and/or a wide area network such as the Internet, for example through a firewall 330.

Persons skilled in the art will appreciate that in accordance with known techniques, functionality at the server side of the network may be distributed over a plurality of different computers. For example, elements may be run as a single “engine” on one server or a separate server may be provided. For example, the game server 308 could run a random generator engine. Alternatively, a separate random number generator server could be provided. Further, persons skilled in the art will appreciate that a plurality of game servers could be provided to run different games or a single game server may run a plurality of different games as required by the terminals.

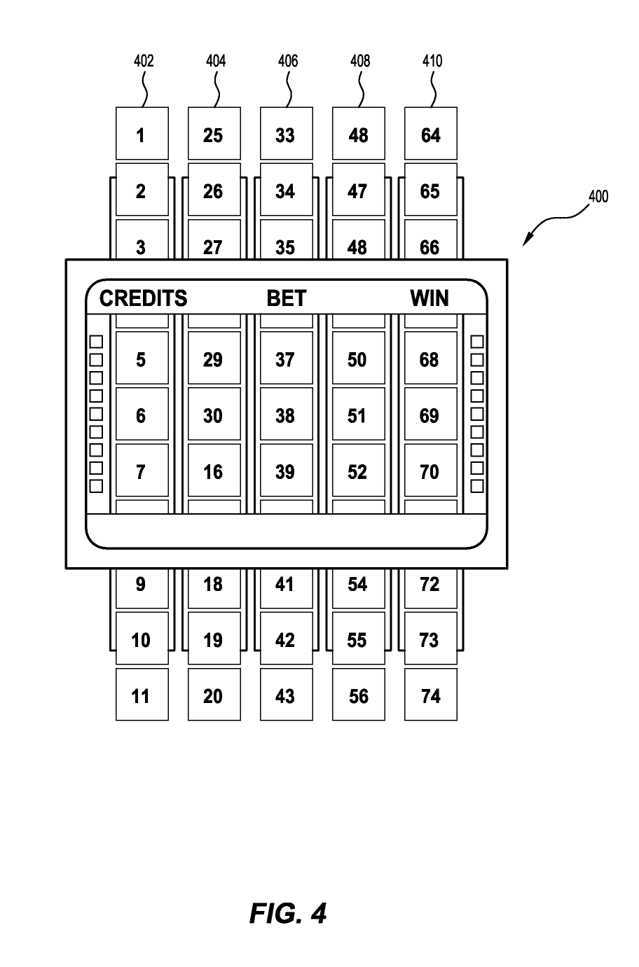

Referring now to FIG. 4 in which is depicted a video representation 400 of a spinning reel game having five spinning reels. A typical game on a typical gaming machine involves the representation of symbols on a series of physical reels with each reel containing symbols. The series of reels are spun to a stop and the displayed symbols are evaluated by the game logic circuitry 200 to determine whether they include a winning combination of symbols. In the representation shown in FIG. 4, the virtual reels 402, 404, 406, 408 and 410 have been extended out of the screen to show that they continue, similar to a physical reel where the symbols wrap around the reel.

At its most basic, a game involves lining up the same symbols along a centre line from the left most reel to the right most reel. A payment is made to the player according to the rules of the game. These rules are referred to as winning symbol combinations. For example, if the same symbol stops from left to right along the centre line then the game will generally pay for a win. This win is then added to the player's credit meter which is stored to RAM 204. The player's credit meter is typically a number shown on the visual display unit 104 and which represents the amount of money a player has available to wager. It is often expressed in credits and can be converted back to a monetary value by multiplying the credit amount by the credit per token value. On a typical machine this is shown as “2¢, $1=50 credits” (this indicates to a player that each credit is worth 2 cents). In Australia the credit meter is also displayed in dollars and cents to aid players in understanding how much is available to wager.

The number of lines available to play is dependent on the rules of the game. Most common numbers of lines are 3, 5, 9, 20, 25, 30, 50 and 100 lines. Each new style of winning combination is created to bring a differentiation of entertainment to the player.

Also displayed on the visual display unit 104 and visible to the player are a “bet” meter which shows the last wager made by the player and a “win” meter which shows the total amount of winnings from the last completed. Both the bet meter and win meter are similarly expressed in credits like the credit meter.

Each combination of winning symbols can be awarded with a prize, a feature or both. The prize is usually in the form of credits awarded to the players' win meter. A prize can also be a trigger to a special feature of the game, such as free games. Any wins during the feature are accumulated to the win meter. The prizes are usually tabularised and shown as artwork on the gaming machine or via a special button on the screen. The prize values can change during gameplay where by prizes for the same symbols are different during the feature than when won outside of the feature.

A player on a typical gaming machine 100 can choose how many lines they want to play and how many credit(s) per line they wish to stake. The combination of the two will start the gameplay. After this point the gaming machine will spin the reels while using the random number generator 210 to determine in what position each of the reels will stop. Once the reels have stopped the rules of the game will determine an outcome, which may include further player selections with or without wagering more credits.

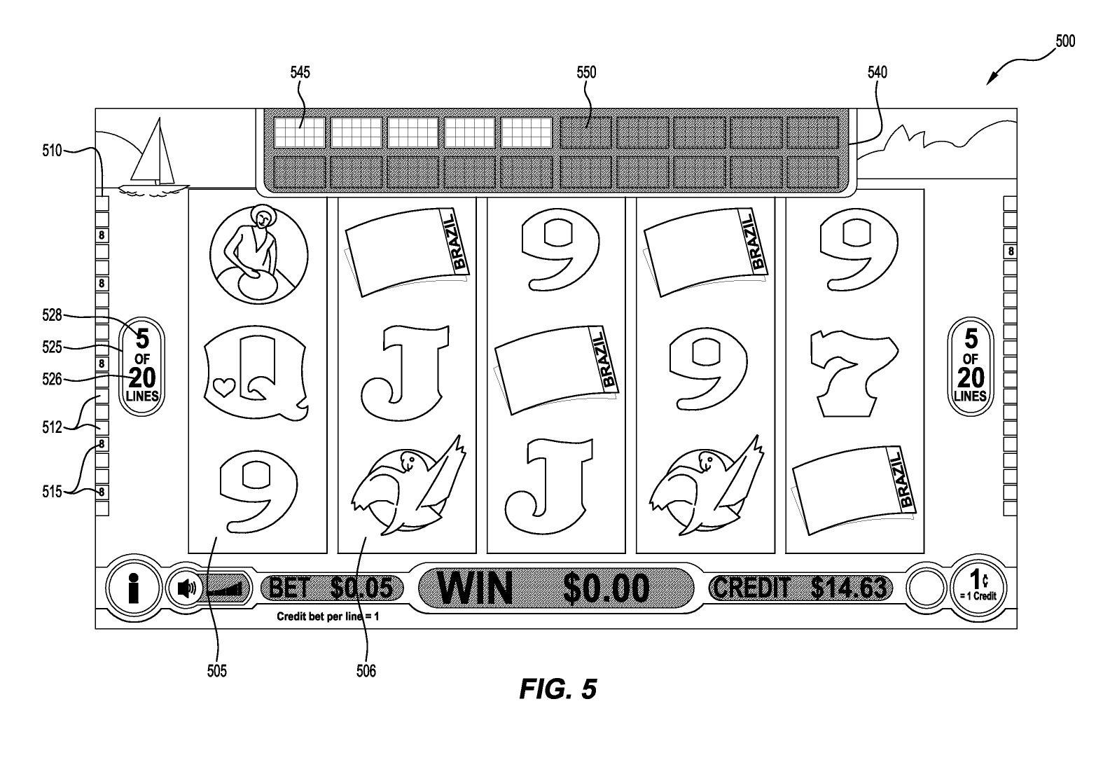

Referring now to FIG. 5, features and functions of game machine 100 and gaming system 300 are described in further detail with respect to display image 500 generated by execution of code comprised in the game software module 232.

As illustrated in FIG. 5, game play on game machine 100 includes a presentation of one or more games of chance, illustrated by successively generated images displayed on display screen 108. Such images include a field of play 505 that comprises a number of symbols 506. Each of the symbols 506 is notionally one of a (possible lengthy) series of symbols within a same column. Each game of chance involves the randomised presentation of a number of symbols 506 within the column (selected from among a larger total set of symbols for that column, including other symbols 506 not shown).

Once the set of symbols 506 to be displayed in the field of play 505 is determined by execution of the game software module 232 in cooperation with the random number generator 210, the game software module 232 in cooperation with the outcome evaluator 203 determines whether the symbols corresponding to one or more selected play lines comprise a winning combination of such symbols, and if so, it is determined that that selected play line is a winning play line.

A play line indication 510 is arranged along each longitudinal periphery of the display of screen 108. The play line indication 510 may be disposed generally along a line that is at the edge of the display area of the screen 108 or alternatively is near the edge. The play line indications 510 comprise a series of non-overlapping graphical patches, which may be in the form of tabs, for example. Each play line indication may be selected according to user input to be an active play line for a succeeding game of chance to be played on the game machine 100.

For each play line indication 510 that corresponds to an active play line, an emphasised play line indication 515 is displayed as part of the series of play line indicators 510. For play line indicators 510 that are inactive, a de-emphasised play line indication 512 is shown in the series. Emphasised play line indications 515 may be shown in a graphically opaque manner, while de-emphasised play line indications 512 may be shown in a transparent or translucent manner, for example.

In between successive games of chance, a player may provide selection input via the tactile input subsystem to select or deselect one or more play line indications 510, thereby toggling such play line indications 510 between selected and deselected states. Each selection or de-selection of a graphical patch corresponding to a play line indication 510 is stored in the memory of the gaming machine 100 or 304 (either RAM 204 or Flash 230) for use by the processor 202 (executing the code of software module 232) to determine, in cooperation with the outcome evaluator 203, whether a selected play line corresponds with a winning outcome in the game of chance.

FIG. 5 also illustrates a virtual input 525 that functions as a play line selection summary portion. Virtual button 525 is displayed generally adjacent or nearby the series of play line indications 510 at or near the periphery of the display screen 108. The play line selection summary portion 525 indicates a number 526 of total selectable play lines and also indicates a number 528 of selected play lines (corresponding to the total number of emphasised graphical patches 515), which is greater than zero and less than or equal to the total number 526 of selectable play lines.

In another embodiment, virtual input 525 may be a physical button or switch, or another input sensor. As described, virtual input 525 displays text on its face, indicating the total number of play lines 526 available for the current game, and how many of the play lines are enabled 528.

Touching virtual input 525 toggles the visibility of a help line pattern indicator which in this example is a drop-down line indicator 540. This toggling may be accompanied by a change in the appearance of input 525. For example, when input 525 is a virtual button displayed on visual display unit 104, it may change colour when it has been pressed once, and return to its original colour when pressed again. Where input 525 has a three-dimensional appearance on visual display 104, it may appear to become sunken in appearance, and appear to be raised to its original position on a second press. Additionally, pressing input 525 may cause a sound effect to indicate to the user that the touch was registered. Optionally, a sound effect may continue for the duration that drop-down help line indicator 540 is visible on the screen.

Drop-down help line indicator 540 may appear on any portion of the screen, such as on either side of the screen, on the bottom of the screen, or along the top of the screen as illustrated in FIG. 5. However, if is preferred that drop-down help line indicator 540 is not positioned so as to block or cover the reel symbols displayed on the reels of the game in play. This allows the user to check the result of an active game against the play lines on drop-down indicator 525.

In the illustrated example, twenty play lines are available for the selected game, with each available play line being displayed on the drop-down help line indicator 540. Play line 545 is an example play line that is shown to be enabled, while play line 550 is an example of a disabled play line. In the illustrated embodiment, disabled play lines 550 are visually distinguishable from the enabled play lines as they are darkened and dull, while the enabled play lines are highlighted. In another embodiment, the play lines may be distinguishable in a different way. The enabled play lines may be shown in colour, while the disabled play lines may be shown in greyscale, for example. In the illustrated example, five of the play lines are enabled, while the remaining fifteen are disabled. In a further embodiment, the winning play lines for the current game may also be indicated on drop-down help line indicator 540. These may be outlined, highlighted in a particular colour, or animated in some way, for example.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

While the foregoing description has been provided by way of example of the preferred embodiments of the present invention as presently contemplated, which utilise gaming machines of the type found in casinos, those skilled in the relevant arts will appreciate that embodiments of the present invention also may have application to internet gaming and/or have application to gaming over a telecommunications network, where mobile handsets are used to display game outcomes and receive player inputs. Such mobile devices include smart phones, notebooks, tablets, iPads and laptop computers. For instance free mobile device games may be offered for download and play on a players personal mobile device as a bonus game play. In such an embodiment the gaming machine may comprise a power interface to enable interaction between the respective devices and/or a communication or wireless interface to enable data transfer. During game play, the gaming machine may be configured to send information to the player's personal mobile device.

Further embodiments may enable a player to upload the outcome of a game or bonus game to a social media site(s), post tournament scores etc.

Certain steps in the processes or process flows described in this disclosure naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another.

A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention.

1. A gaming machine comprising:
a display to display images;
a user interface to receive input from a player;
a memory; and
a game controller configured to access the memory, control display of the images and process input received via the user interface, the game controller further configured to:
control generation and display of a game play sequence comprising a presentation of one or more games of chance;
store in the memory data describing a plurality of available play lines for the game play sequence, wherein each of the available play lines comprises a graphical representation of a unique pattern of selected symbols;
receive from the player via the user interface a selection of the plurality of available play lines;
in response to the received input from the player, display a help line pattern indicator in proximity to the presentation on the display, wherein the help line pattern indicator comprises at least a subset of the plurality of available play lines including each of the selected play lines; and to
control display of the graphical representations in the help line pattern indicator to graphically distinguish each of the selected available play lines from remaining play lines.

2. The gaming machine of claim 1, wherein graphically distinguishing each of the selected available play lines from remaining play lines comprises highlighting the selected available play lines.

3. The gaming machine of claim 1, wherein graphically distinguishing each of the selected available play lines from remaining play lines comprises providing only the selected available play lines in colour whilst providing the remaining available play lines in greyscale.

4. The gaming machine of claim 1, wherein the user interface comprises a touch screen which interfaces with the display.

5. The gaming machine of claim 4, wherein the user interface comprises at least one virtual button displayed on the touch screen, and wherein input from the player is by way of touching the touch screen in proximity to the button displayed.

6. The gaming machine of claim 5, wherein the game controller alters the appearance of the virtual button when it detects that the virtual button has been activated.

7. The gaming machine of claim 1 wherein the user interface comprises at least one of a physical button and switch.

8. The gaming machine of claim 1, wherein the game controller is further configured to display a summary indication of selected and selectable play lines.

9. The gaming machine of claim 8, wherein the summary indication indicates how many of the selectable play lines are selected for a succeeding game of chance and also indicates a total of how many play lines are selectable.

10. The gaming machine of claim 8 wherein the user interface comprises at least one virtual button displayed on the touch screen, wherein input from the player is by way of touching the touch screen in proximity to the button displayed, and wherein the virtual button comprises the summary indication of selected and selectable play lines.

11. The gaming machine of claim 1 wherein the game controller is further configured to generate audio input upon receipt of input from the player.

12. The gaming machine of claim 1 wherein the game controller is further configured to display one or more play line indications comprising a sequence of graphical patches, wherein each graphical patch is associated with one of the one or more selectable play lines.

13. The gaming machine of any claim 1, wherein each of the one or more selected play line indications is positioned at or near a periphery of the display and each selected play line indicators indicates which one or more of a plurality of selectable play lines are active for a succeeding game of chance.

14. The gaming machine of claim 1 wherein the gaming controller is further configured to display selectable play line indications representing inactive play lines with a transparent graphical patch and to display play line indications representing active play lines with an opaque graphical patch.

15. The gaming machine of claim 14 wherein each of the selectable play lines has a unique identifier.

16. The gaming machine of claim 15, wherein the unique identifier is a number of the play line.

17. The gaming machine of claim 15, wherein the unique identifier is displayed over the graphical patch for the respective play line during selected times.

18. A method of game play executed by a computerised game controller, the method comprising:
controlling generation and display of a game play sequence comprising a presentation of one or more games of chance;
storing in a memory data describing a plurality of available play lines for the game play sequence, wherein each of the available play lines comprises a graphical representation of a unique pattern of selected symbols;
receiving from a player via a user interface a selection of the plurality of available play lines; in response to the received input from the player,
displaying a help line pattern indicator in proximity to the presentation on the display, wherein the help line pattern indicator comprises at least a subset of the plurality of available play lines including each of the selected play lines; and
controlling display of the graphical representations in the help line pattern indicator to graphically distinguish each of the selected available play lines from remaining play lines.

19. A method of game play executed by a computerised game controller according to claim 18, comprising graphically distinguishing each of the selected available play lines from remaining play lines.

20. A gaming system comprising at least one server and at least one client device, wherein the at least one server and at least one client device are configured to cooperate with each other to execute program instructions to:
control generation and display of a game play sequence comprising a presentation of one or more games of chance;
store in a memory data describing a plurality of available play lines for the game play sequence, wherein each of the available play lines comprises a graphical representation of a unique pattern of selected symbols;
receive from a player via a user interface a selection of the plurality of available play lines; in response to the received input from the player,
display a help line pattern indicator in proximity to the presentation on the display, wherein the help line pattern indicator comprises at least a subset of the plurality of available play lines including each of the selected play lines; and
control display of the graphical representations in the help line pattern indicator to graphically distinguish each of the selected available play lines from remaining play lines.

21. A computer-readable storage medium storing executable program code that, when executed by a game controller, causes the game controller to:
control generation and display of a game play sequence comprising a presentation of one or more games of chance;
store in the memory data describing a plurality of available play lines for the game play sequence, wherein each of the available play lines comprises a graphical representation of a unique pattern of selected symbols;
receive from the player via the user interface a selection of the plurality of available play lines;
in response to the received input from the player, display a help line pattern indicator in proximity to the presentation on the display, wherein the help line pattern indicator comprises at least a subset of the plurality of available play lines including each of the selected play lines; and to
control display of the graphical representations in the help line pattern indicator to graphically distinguish each of the selected available play lines from remaining play lines.
